(19) United States
(12) Patent Application Publication
(10) Pub. No.: US 2016/0249104 A1
(43) Pub. Date: Aug. 25, 2016

(54) SYSTEMS AND METHODS FOR SEAMLESSLY TRANSITIONING FROM A BROADCAST MEDIA ASSET TO A RELATED ON-DEMAND MEDIA ASSET

(71) Applicant: ROVI GUIDES, INC., Santa Clara, CA (US)

(72) Inventor: David Chung, Santa Clara, CA (US)

(21) Appl. No.: 14/631,494

(22) Filed: Feb. 25, 2015

(51) Int. Cl. H04N 21/472; H04N 21/442

(52) U.S. Cl. CPC H04N 21/47202; H04N 21/44204

(57) ABSTRACT

Systems and methods are disclosed herein for seamlessly transitioning a user from viewing broadcast media to viewing on-demand media. In particular, the systems and methods are designed to identify an on-demand media asset that is related to the broadcast media asset the user is consuming, and transition the user from consuming the broadcast media asset to the on-demand media asset upon the ending of the broadcast media asset. When the broadcast media asset ends, the on-demand media asset may be generated for display instead of whatever media asset is scheduled to be broadcast next by the provider of the broadcast media asset.

### BACKGROUND OF THE INVENTION

Broadcast media providers, such as television networks and radio stations, often seek to target a broad base of users, each of whom have individual interests. As a consequence, while a given user may be interested in a given media asset available from a broadcast media provider, the same user may be disinterested in a media asset that is to be broadcast following the broadcast time of the given media asset. A user who recognizes his or her disinterest in the next broadcast program may consequentially discontinue consuming media from the broadcast media provider, thus reducing the opportunity for revenue to be obtained through the user's continued attention (e.g., through advertisement revenue).

### SUMMARY

Systems and methods are disclosed herein for seamlessly transitioning a user from viewing broadcast media to viewing on-demand media. In particular, the systems and methods are designed to identify an on-demand media asset that is related to the broadcast media asset the user is consuming, and transition the user from consuming the broadcast media asset to the on-demand media asset upon the ending of the broadcast media asset. For example, if a user is watching, on broadcast television, an episode of a season of media assets, such as season 4, episode 2 of “Seinfeld,” the systems and methods disclosed herein may identify an on-demand episode that is the next episode of the season (e.g., season 4, episode 3 of Seinfeld). Upon doing so, when season 4, episode 2 of Seinfeld ends, the systems and methods may cause season 4, episode 3 to be generated for display instead of whatever media asset is scheduled to be broadcast next by the provider of the broadcast media asset.

In some aspects, control circuitry may identify a broadcast media asset that a user is viewing. For example, control circuitry may read VBI data that is transmitted with a broadcast video signal for metadata describing the broadcast media asset that the user is currently viewing. As another example, control circuitry may consult media guidance data, such as schedule data, to learn which broadcast media asset is scheduled to be broadcast from the media broadcast source.

In some embodiments, control circuitry may identify an on-demand media asset that is related to the broadcast media asset that the user is viewing. For example, control circuitry may identify attributes of the broadcast media asset, such as whether the broadcast media asset is part of a series, whether the broadcast media asset is part of a category (e.g., sports) or genre (e.g., children's movie). Upon identifying attributes of the broadcast media asset, control circuitry may compare one or more of the identified attributes of the broadcast media asset against attributes of on-demand media assets. As an example, control circuitry may query a database to search for on-demand media assets that are associated with attributes that match some or all of the attributes of the broadcast media asset. In the event that control circuitry identifies multiple on-demand media assets that are associated with attributes that match those of the broadcast media asset, control circuitry may determine an on-demand media asset that either has the most attributes in common with the broadcast media asset, or may determine an on-demand media asset that shares a most important attribute with the broadcast media asset, or may use any other “tiebreaker” mechanism.

In some embodiments, control circuitry may determine that the broadcast media asset has ended. Control circuitry may perform this determination by consulting a schedule to learn a time at which the broadcast media asset is scheduled to end. Control circuitry may, at the time control circuitry learns that the broadcast media asset is scheduled to end, determine that the broadcast media asset has ended.

In some embodiments, in response to determining that the broadcast media asset has ended, control circuitry may automatically generate for display the on-demand media asset. For example, in order to automatically generate for display the on-demand media asset, control circuitry may switch an input source away from a broadcast media source toward an on-demand source. As an example of this, control circuitry may automatically cause a broadcast channel to be tuned away from and an on-demand channel to be tuned to, where the on-demand channel is configured to provide the identified on-demand media asset at the time the on-demand channel is switched to.

In some embodiments, control circuitry may generate for display an interactive option for returning to a broadcast source of the broadcast media asset. As an example, control circuitry may, at the time that the on-demand media asset is generated for display, generate an overlay on top of the on-demand media asset including a selectable option for returning to the broadcast media source. Such an overlay may include a prompt, such as one that says “Would you like to continue viewing this on-demand media asset that is similar to the media asset you just viewed, or would you like to return to channel ABC to view an episode of Family Guy?” If control circuitry detects a selection of the selectable option from the user, control circuitry may tune back to the broadcast media source, such that the next media asset scheduled to be broadcast from the broadcast media source is caused to be generated for display to the user.

In some embodiments, control circuitry may determine that the broadcast media asset is about to end. As described above and below, control circuitry may perform this determination by consulting schedule data corresponding to the broadcast media asset in order to learn when the broadcast media asset is scheduled to end, and compare that to a current time in order to determine that the time is within, for example, one minute of the broadcast media asset's schedule end time. In response to determining that the broadcast media asset is about to end, control circuitry may generate for display a notification that the on-demand media asset will be played back when the broadcast media asset ends. For example, control circuitry may generate for display a prompt or alert that the user will be tuned away from the broadcast media source that provides the broadcast media asset upon determining that the broadcast media asset is about to end. The notification may include a selectable option that, when selected, causes control circuitry to refrain from tuning away from the broadcast media source, thus causing control circuitry to refrain from automatically generating for display the on-demand media asset.

In some embodiments, control circuitry identifies the on-demand media asset that is related to the broadcast media asset by selecting the on-demand media asset from a plurality of media assets that are related to the broadcast media asset, where the selecting is based on attributes of a profile corresponding to the user. As an example, as described above and below, control circuitry may identify a plurality of on-demand media assets that are related to the broadcast media asset. In order to choose which on-demand media asset to generate for display when control circuitry determines that the broadcast media asset has ended, control circuitry may consider attributes of a user profile. As an example, if the broadcast media asset is an action movie starring actor Tom Cruise, control circuitry may identify (1) another action movie, and (2) a drama movie starring Tom Cruise as an actor. Control circuitry may determine that the user enjoys drama movies based on attributes of the user's profile. Based on this determination, control circuitry may cause the drama movie starring Tom Cruise to be generated for display as the on-demand media asset, rather than the another action movie, because the user's profile reflects a preference for drama movies.

In some embodiments, control circuitry may determine that playback of the on-demand media asset has ended. For example, control circuitry may detect an “end-of-program” signal upon the ending of the on-demand media asset. Upon detecting such a signal, control circuitry may generate for display a second broadcast media asset, where the second broadcast media asset is received from a broadcast source that provided the broadcast media asset. For example, control circuitry may cause media from the broadcast media source to be generated for display upon determining that the on-demand media asset has ended, such that media being broadcast by the media source at the time the on-demand media asset has ended is generated for display to the user. As an example, control circuitry may, upon the on-demand media asset ending, cause a user equipment to tune to the broadcast media source such that whatever media asset is presently being broadcast by the broadcast media source is generated for display to the user.

In some embodiments, control circuitry may determine whether a second broadcast media asset that is to follow the broadcast media asset when the broadcast media asset has ended is preferred by the user. For example, control circuitry may determine that the user enjoys viewing episodes from the television series “Seinfeld.” Control circuitry may determine that, immediately subsequent to the broadcast media asset's end time, an episode of Seinfeld will be broadcast by the broadcast media provider. Control circuitry may, therefore, determine that a second broadcast media asset (e.g., “Seinfeld”) that is to follow the broadcast media asset is preferred by the user. Control circuitry may, responsively, refrain from automatically generating for display the on-demand media asset. For example, in the event that control circuitry determines that a second broadcast media asset that is to follow the broadcast media asset is preferred by the user, control circuitry may cause the on-demand media asset that is similar to the broadcast media asset to not be automatically generated for display. In the “Seinfeld” example, of this paragraph, for example, control circuitry may determine that, because the user enjoys the series “Seinfeld,” control circuitry will not automatically cause “Seinfeld” to be tuned away from in favor of the selected on-demand media asset.

In some embodiments, control circuitry may generate for display a selectable option for refraining from automatically generating for display the on-demand media asset. For example, control circuitry may cause a prompt to be displayed to a user including a selectable option, which, when selected, enables the user to continue receiving media from the broadcast media source. Control circuitry may, in response to receiving a selection of the selectable option, refrain from automatically generating for display the on-demand media asset, such that the second broadcast media asset is caused to be generated for display. For example, when the selectable option is selected from the prompt, control circuitry may cause media from the broadcast media source to continuously be displayed without interrupting the display of the broadcast media asset or a next media asset to be broadcasted by the broadcast media source with a display of the on-demand media asset.

### BRIEF DESCRIPTION OF THE DRAWINGS

The above and other objects and advantages of the disclosure will be apparent upon consideration of the following detailed description, taken in conjunction with the accompanying drawings, in which like reference characters refer to like parts throughout, and in which:

FIG. 1 shows an illustrative embodiment of a display screen that may be used to provide media guidance application listings and other media guidance information, in accordance with some embodiments of the disclosure;

FIG. 2 shows another illustrative embodiment of a display screen that may be used to provide media guidance application listings, in accordance with some embodiments of the disclosure;

FIG. 3 is a block diagram of an illustrative user equipment (UE) device in accordance with some embodiments of the disclosure;

FIG. 4 is a block diagram of an illustrative media system in accordance with some embodiments of the disclosure;

FIG. 5 shows an illustrative embodiment of a user equipment that seamlessly transitions a user from a broadcast media asset to an on-demand media asset, in accordance with some embodiments of the disclosure; and

FIG. 6 is a flowchart of illustrative steps involved in seamlessly transitioning a user from a broadcast media asset to an on-demand media asset, in accordance with some embodiments of the disclosure.

### DETAILED DESCRIPTION

Systems and methods are disclosed herein for seamlessly transitioning a user from viewing broadcast media to viewing on-demand media. In particular, the systems and methods are designed to identify an on-demand media asset that is related to the broadcast media asset the user is consuming, and transition the user from consuming the broadcast media asset to the on-demand media asset upon the ending of the broadcast media asset. For example, if a user is watching, on broadcast television, an episode of a season of media assets, such as season 4, episode 2 of Seinfeld, the systems and methods disclosed herein may identify an on-demand episode that is the next episode of the season (e.g., season 4, episode 3 of Seinfeld). Upon doing so, when season 4, episode 2 of Seinfeld ends, the systems and methods may cause season 4, episode 3 to be generated for display instead of whatever media asset is scheduled to be broadcast next by the provider of the broadcast media asset.

In some aspects, control circuitry may identify a broadcast media asset that a user is viewing. For example, control circuitry may read VBI data that is transmitted with a broadcast video signal for metadata describing the broadcast media asset that the user is currently viewing. As another example, control circuitry may consult media guidance data, such as schedule data, to learn which broadcast media asset is scheduled to be broadcast from the media broadcast source.

In some embodiments, control circuitry may identify an on-demand media asset that is related to the broadcast media asset that the user is viewing. For example, control circuitry may identify attributes of the broadcast media asset, such as whether the broadcast media asset is part of a series, whether the broadcast media asset is part of a category (e.g., sports) or genre (e.g., children's movie). Upon identifying attributes of the broadcast media asset, control circuitry may compare one or more of the identified attributes of the broadcast media asset against attributes of on-demand media assets. As an example, control circuitry may query a database to search for on-demand media assets that are associated with attributes that match some or all of the attributes of the broadcast media asset. In the event that control circuitry identifies multiple on-demand media assets that are associated with attributes that match those of the broadcast media asset, control circuitry may determine an on-demand media asset that either has the most attributes in common with the broadcast media asset, or may determine an on-demand media asset that shares a most important attribute with the broadcast media asset, or may use any other “tiebreaker” mechanism.

In some embodiments, control circuitry may determine that the broadcast media asset has ended. Control circuitry may perform this determination by consulting a schedule to learn a time at which the broadcast media asset is scheduled to end. Control circuitry may, at the time control circuitry learns that the broadcast media asset is scheduled to end, determine that the broadcast media asset has ended.

In some embodiments, in response to determining that the broadcast media asset has ended, control circuitry may automatically generate for display the on-demand media asset. For example, in order to automatically generate for display the on-demand media asset, control circuitry 304 may switch an input source away from a broadcast media source toward an on-demand source. As an example of this, control circuitry may automatically cause a broadcast channel to be tuned away from and an on-demand channel to be tuned to, where the on-demand channel is configured to provide the identified on-demand media asset at the time the on-demand channel is switched to.

The amount of content available to users in any given content delivery system can be substantial. Consequently, many users desire a form of media guidance through an interface that allows users to efficiently navigate content selections and easily identify content that they may desire. An application that provides such guidance is referred to herein as an interactive media guidance application or, sometimes, a media guidance application or a guidance application.

Interactive media guidance applications may take various forms depending on the content for which they provide guidance. One typical type of media guidance application is an interactive television program guide. Interactive television program guides (sometimes referred to as electronic program guides) are well-known guidance applications that, among other things, allow users to navigate among and locate many types of content or media assets. Interactive media guidance applications may generate graphical user interface screens that enable a user to navigate among, locate and select content. As referred to herein, the terms “media asset” and “content” should be understood to mean an electronically consumable user asset, such as television programming, as well as pay-per-view programs, on-demand programs (as in video-on-demand (VOD) systems), Internet content (e.g., streaming content, downloadable content, Webcasts, etc.), video clips, audio, content information, pictures, rotating images, documents, playlists, websites, articles, books, electronic books, blogs, advertisements, chat sessions, social media, applications, games, and/or any other media or multimedia and/or combination of the same. Guidance applications also allow users to navigate among and locate content. As referred to herein, the term “multimedia” should be understood to mean content that utilizes at least two different content forms described above, for example, text, audio, images, video, or interactivity content forms. Content may be recorded, played, displayed or accessed by user equipment devices, but can also be part of a live performance.

The media guidance application and/or any instructions for performing any of the embodiments discussed herein may be encoded on computer readable media. Computer readable media includes any media capable of storing data. The computer readable media may be transitory, including, but not limited to, propagating electrical or electromagnetic signals, or may be non-transitory including, but not limited to, volatile and non-volatile computer memory or storage devices such as a hard disk, floppy disk, USB drive, DVD, CD, media cards, register memory, processor caches, Random Access Memory (“RAM”), etc.

With the advent of the Internet, mobile computing, and high-speed wireless networks, users are accessing media on user equipment devices on which they traditionally did not. As referred to herein, the phrase “user equipment device,” “user equipment,” “user device,” “electronic device,” “electronic equipment,” “media equipment device,” or “media device” should be understood to mean any device for accessing the content described above, such as a television, a Smart TV, a set-top box, an integrated receiver decoder (IRD) for handling satellite television, a digital storage device, a digital media receiver (DMR), a digital media adapter (DMA), a streaming media device, a DVD player, a DVD recorder, a connected DVD, a local media server, a BLU-RAY player, a BLU-RAY recorder, a personal computer (PC), a laptop computer, a tablet computer, a WebTV box, a personal computer television (PC/TV), a PC media server, a PC media center, a hand-held computer, a stationary telephone, a personal digital assistant (PDA), a mobile telephone, a portable video player, a portable music player, a portable gaming machine, a smart phone, or any other television equipment, computing equipment, or wireless device, and/or combination of the same. In some embodiments, the user equipment device may have a front facing screen and a rear facing screen, multiple front screens, or multiple angled screens. In some embodiments, the user equipment device may have a front facing camera and/or a rear facing camera. On these user equipment devices, users may be able to navigate among and locate the same content available through a television. Consequently, media guidance may be available on these devices, as well. The guidance provided may be for content available only through a television, for content available only through one or more of other types of user equipment devices, or for content available both through a television and one or more of the other types of user equipment devices. The media guidance applications may be provided as on-line applications (i.e., provided on a web-site), or as stand-alone applications or clients on user equipment devices. Various devices and platforms that may implement media guidance applications are described in more detail below.

One of the functions of the media guidance application is to provide media guidance data to users. As referred to herein, the phrase “media guidance data” or “guidance data” should be understood to mean any data related to content or data used in operating the guidance application. For example, the guidance data may include program information, guidance application settings, user preferences, user profile information, media listings, media-related information (e.g., broadcast times, broadcast channels, titles, descriptions, ratings information (e.g., parental control ratings, critic's ratings, etc.), genre or category information, actor information, logo data for broadcasters' or providers' logos, etc.), media format (e.g., standard definition, high definition, 3D, etc.), advertisement information (e.g., text, images, media clips, etc.), on-demand information, blogs, websites, and any other type of guidance data that is helpful for a user to navigate among and locate desired content selections.

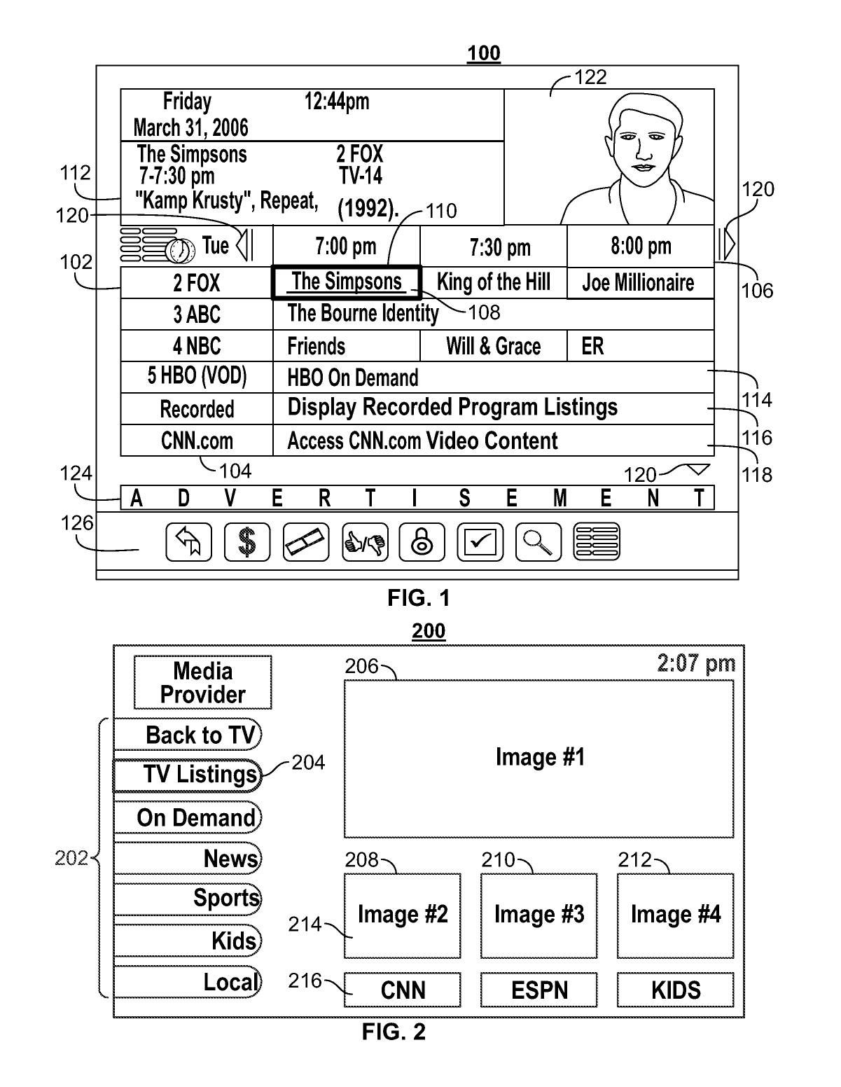

FIGS. 1-2 show illustrative display screens that may be used to provide media guidance data. The display screens shown in FIGS. 1-2 may be implemented on any suitable user equipment device or platform. While the displays of FIGS. 1-2 are illustrated as full screen displays, they may also be fully or partially overlaid over content being displayed. A user may indicate a desire to access content information by selecting a selectable option provided in a display screen (e.g., a menu option, a listings option, an icon, a hyperlink, etc.) or pressing a dedicated button (e.g., a GUIDE button) on a remote control or other user input interface or device. In response to the user's indication, the media guidance application may provide a display screen with media guidance data organized in one of several ways, such as by time and channel in a grid, by time, by channel, by source, by content type, by category (e.g., movies, sports, news, children, or other categories of programming), or other predefined, user-defined, or other organization criteria.

FIG. 1 shows illustrative grid of a program listings display 100 arranged by time and channel that also enables access to different types of content in a single display. Display 100 may include grid 102 with: (1) a column of channel/content type identifiers 104, where each channel/content type identifier (which is a cell in the column) identifies a different channel or content type available; and (2) a row of time identifiers 106, where each time identifier (which is a cell in the row) identifies a time block of programming. Grid 102 also includes cells of program listings, such as program listing 108, where each listing provides the title of the program provided on the listing's associated channel and time. With a user input device, a user can select program listings by moving highlight region 110. Information relating to the program listing selected by highlight region 110 may be provided in program information region 112. Region 112 may include, for example, the program title, the program description, the time the program is provided (if applicable), the channel the program is on (if applicable), the program's rating, and other desired information.

In addition to providing access to linear programming (e.g., content that is scheduled to be transmitted to a plurality of user equipment devices at a predetermined time and is provided according to a schedule), the media guidance application also provides access to non-linear programming (e.g., content accessible to a user equipment device at any time and is not provided according to a schedule). Non-linear programming may include content from different content sources including on-demand content (e.g., VOD), Internet content (e.g., streaming media, downloadable media, etc.), locally stored content (e.g., content stored on any user equipment device described above or other storage device), or other time-independent content. On-demand content may include movies or any other content provided by a particular content provider (e.g., HBO On Demand providing “The Sopranos” and “Curb Your Enthusiasm”). HBO ON DEMAND is a service mark owned by Time Warner Company L.P. et al. and THE SOPRANOS and CURB YOUR ENTHUSIASM are trademarks owned by the Home Box Office, Inc. Internet content may include web events, such as a chat session or Webcast, or content available on-demand as streaming content or downloadable content through an Internet web site or other Internet access (e.g. FTP).

Grid 102 may provide media guidance data for non-linear programming including on-demand listing 114, recorded content listing 116, and Internet content listing 118. A display combining media guidance data for content from different types of content sources is sometimes referred to as a “mixed-media” display. Various permutations of the types of media guidance data that may be displayed that are different than display 100 may be based on user selection or guidance application definition (e.g., a display of only recorded and broadcast listings, only on-demand and broadcast listings, etc.). As illustrated, listings 114, 116, and 118 are shown as spanning the entire time block displayed in grid 102 to indicate that selection of these listings may provide access to a display dedicated to on-demand listings, recorded listings, or Internet listings, respectively. In some embodiments, listings for these content types may be included directly in grid 102. Additional media guidance data may be displayed in response to the user selecting one of the navigational icons 120. (Pressing an arrow key on a user input device may affect the display in a similar manner as selecting navigational icons 120.)

Display 100 may also include video region 122, advertisement 124, and options region 126. Video region 122 may allow the user to view and/or preview programs that are currently available, will be available, or were available to the user. The content of video region 122 may correspond to, or be independent from, one of the listings displayed in grid 102. Grid displays including a video region are sometimes referred to as picture-in-guide (PIG) displays. PIG displays and their functionalities are described in greater detail in Satterfield et al. U.S. Pat. No. 6,564,378, issued May 13, 2003 and Yuen et al. U.S. Pat. No. 6,239,794, issued May 29, 2001, which are hereby incorporated by reference herein in their entireties. PIG displays may be included in other media guidance application display screens of the embodiments described herein.

Advertisement 124 may provide an advertisement for content that, depending on a viewer's access rights (e.g., for subscription programming), is currently available for viewing, will be available for viewing in the future, or may never become available for viewing, and may correspond to or be unrelated to one or more of the content listings in grid 102. Advertisement 124 may also be for products or services related or unrelated to the content displayed in grid 102. Advertisement 124 may be selectable and provide further information about content, provide information about a product or a service, enable purchasing of content, a product, or a service, provide content relating to the advertisement, etc. Advertisement 124 may be targeted based on a user's profile/preferences, monitored user activity, the type of display provided, or on other suitable targeted advertisement bases.

While advertisement 124 is shown as rectangular or banner shaped, advertisements may be provided in any suitable size, shape, and location in a guidance application display. For example, advertisement 124 may be provided as a rectangular shape that is horizontally adjacent to grid 102. This is sometimes referred to as a panel advertisement. In addition, advertisements may be overlaid over content or a guidance application display or embedded within a display. Advertisements may also include text, images, rotating images, video clips, or other types of content described above. Advertisements may be stored in a user equipment device having a guidance application, in a database connected to the user equipment, in a remote location (including streaming media servers), or on other storage means, or a combination of these locations. Providing advertisements in a media guidance application is discussed in greater detail in, for example, Knudson et al., U.S. Patent Application Publication No. 2003/0110499, filed Jan. 17, 2003; Ward, III et al. U.S. Pat. No. 6,756,997, issued Jun. 29, 2004; and Schein et al. U.S. Pat. No. 6,388,714, issued May 14, 2002, which are hereby incorporated by reference herein in their entireties. It will be appreciated that advertisements may be included in other media guidance application display screens of the embodiments described herein.

Options region 126 may allow the user to access different types of content, media guidance application displays, and/or media guidance application features. Options region 126 may be part of display 100 (and other display screens described herein), or may be invoked by a user by selecting an on-screen option or pressing a dedicated or assignable button on a user input device. The selectable options within options region 126 may concern features related to program listings in grid 102 or may include options available from a main menu display. Features related to program listings may include searching for other air times or ways of receiving a program, recording a program, enabling series recording of a program, setting program and/or channel as a favorite, purchasing a program, or other features. Options available from a main menu display may include search options, VOD options, parental control options, Internet options, cloud-based options, device synchronization options, second screen device options, options to access various types of media guidance data displays, options to subscribe to a premium service, options to edit a user's profile, options to access a browse overlay, or other options.

The media guidance application may be personalized based on a user's preferences. A personalized media guidance application allows a user to customize displays and features to create a personalized “experience” with the media guidance application. This personalized experience may be created by allowing a user to input these customizations and/or by the media guidance application monitoring user activity to determine various user preferences. Users may access their personalized guidance application by logging in or otherwise identifying themselves to the guidance application. Customization of the media guidance application may be made in accordance with a user profile. The customizations may include varying presentation schemes (e.g., color scheme of displays, font size of text, etc.), aspects of content listings displayed (e.g., only HDTV or only 3D programming, user-specified broadcast channels based on favorite channel selections, re-ordering the display of channels, recommended content, etc.), desired recording features (e.g., recording or series recordings for particular users, recording quality, etc.), parental control settings, customized presentation of Internet content (e.g., presentation of social media content, e-mail, electronically delivered articles, etc.) and other desired customizations.

The media guidance application may allow a user to provide user profile information or may automatically compile user profile information. The media guidance application may, for example, monitor the content the user accesses and/or other interactions the user may have with the guidance application. Additionally, the media guidance application may obtain all or part of other user profiles that are related to a particular user (e.g., from other web sites on the Internet the user accesses, such as www.allrovi.com, from other media guidance applications the user accesses, from other interactive applications the user accesses, from another user equipment device of the user, etc.), and/or obtain information about the user from other sources that the media guidance application may access. As a result, a user can be provided with a unified guidance application experience across the user's different user equipment devices. This type of user experience is described in greater detail below in connection with FIG. 4. Additional personalized media guidance application features are described in greater detail in Ellis et al., U.S. Patent Application Publication No. 2005/0251827, filed Jul. 11, 2005, Boyer et al., U.S. Pat. No. 7,165,098, issued Jan. 16, 2007, and Ellis et al., U.S. Patent Application Publication No. 2002/0174430, filed Feb. 21, 2002, which are hereby incorporated by reference herein in their entireties.

Another display arrangement for providing media guidance is shown in FIG. 2. Video mosaic display 200 includes selectable options 202 for content information organized based on content type, genre, and/or other organization criteria. In display 200, television listings option 204 is selected, thus providing listings 206, 208, 210, and 212 as broadcast program listings. In display 200 the listings may provide graphical images including cover art, still images from the content, video clip previews, live video from the content, or other types of content that indicate to a user the content being described by the media guidance data in the listing. Each of the graphical listings may also be accompanied by text to provide further information about the content associated with the listing. For example, listing 208 may include more than one portion, including media portion 214 and text portion 216. Media portion 214 and/or text portion 216 may be selectable to view content in full-screen or to view information related to the content displayed in media portion 214 (e.g., to view listings for the channel that the video is displayed on).

The listings in display 200 are of different sizes (i.e., listing 206 is larger than listings 208, 210, and 212), but if desired, all the listings may be the same size. Listings may be of different sizes or graphically accentuated to indicate degrees of interest to the user or to emphasize certain content, as desired by the content provider or based on user preferences. Various systems and methods for graphically accentuating content listings are discussed in, for example, Yates, U.S. Patent Application Publication No. 2010/0153885, filed Dec. 29, 2005, which is hereby incorporated by reference herein in its entirety.

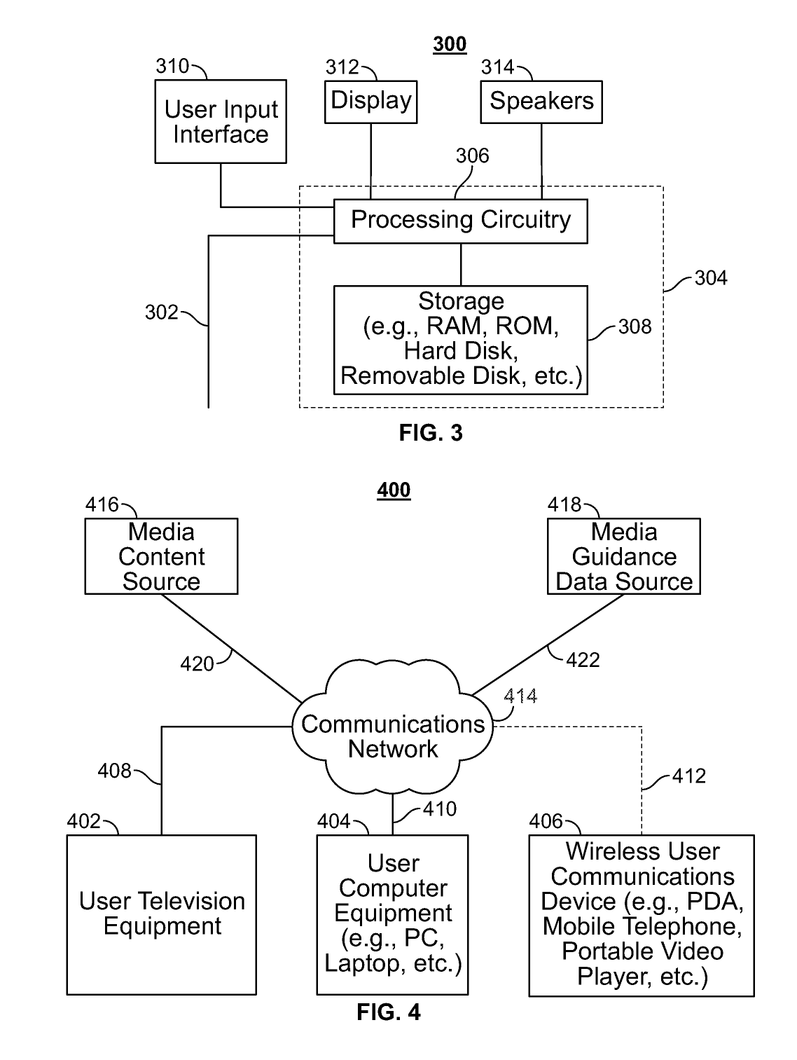

Users may access content and the media guidance application (and its display screens described above and below) from one or more of their user equipment devices. FIG. 3 shows a generalized embodiment of illustrative user equipment device 300. More specific implementations of user equipment devices are discussed below in connection with FIG. 4. User equipment device 300 may receive content and data via input/output (hereinafter “I/O”) path 302. I/O path 302 may provide content (e.g., broadcast programming, on-demand programming, Internet content, content available over a local area network (LAN) or wide area network (WAN), and/or other content) and data to control circuitry 304, which includes processing circuitry 306 and storage 308. Control circuitry 304 may be used to send and receive commands, requests, and other suitable data using I/O path 302. I/O path 302 may connect control circuitry 304 (and specifically processing circuitry 306) to one or more communications paths (described below). I/O functions may be provided by one or more of these communications paths, but are shown as a single path in FIG. 3 to avoid overcomplicating the drawing.

Control circuitry 304 may be based on any suitable processing circuitry such as processing circuitry 306. As referred to herein, processing circuitry should be understood to mean circuitry based on one or more microprocessors, microcontrollers, digital signal processors, programmable logic devices, field-programmable gate arrays (FPGAs), application-specific integrated circuits (ASICs), etc., and may include a multi-core processor (e.g., dual-core, quad-core, hexa-core, or any suitable number of cores) or supercomputer. In some embodiments, processing circuitry may be distributed across multiple separate processors or processing units, for example, multiple of the same type of processing units (e.g., two Intel Core i7 processors) or multiple different processors (e.g., an Intel Core i5 processor and an Intel Core i7 processor). In some embodiments, control circuitry 304 executes instructions for a media guidance application stored in memory (i.e., storage 308). Specifically, control circuitry 304 may be instructed by the media guidance application to perform the functions discussed above and below. For example, the media guidance application may provide instructions to control circuitry 304 to generate the media guidance displays. In some implementations, any action performed by control circuitry 304 may be based on instructions received from the media guidance application.

In client-server based embodiments, control circuitry 304 may include communications circuitry suitable for communicating with a guidance application server or other networks or servers. The instructions for carrying out the above mentioned functionality may be stored on the guidance application server. Communications circuitry may include a cable modem, an integrated services digital network (ISDN) modem, a digital subscriber line (DSL) modem, a telephone modem, Ethernet card, or a wireless modem for communications with other equipment, or any other suitable communications circuitry. Such communications may involve the Internet or any other suitable communications networks or paths (which is described in more detail in connection with FIG. 4). In addition, communications circuitry may include circuitry that enables peer-to-peer communication of user equipment devices, or communication of user equipment devices in locations remote from each other (described in more detail below).

Memory may be an electronic storage device provided as storage 308 that is part of control circuitry 304. As referred to herein, the phrase “electronic storage device” or “storage device” should be understood to mean any device for storing electronic data, computer software, or firmware, such as random-access memory, read-only memory, hard drives, optical drives, digital video disc (DVD) recorders, compact disc (CD) recorders, BLU-RAY disc (BD) recorders, BLU-RAY 3D disc recorders, digital video recorders (DVR, sometimes called a personal video recorder, or PVR), solid state devices, quantum storage devices, gaming consoles, gaming media, or any other suitable fixed or removable storage devices, and/or any combination of the same. Storage 308 may be used to store various types of content described herein as well as media guidance data described above. Nonvolatile memory may also be used (e.g., to launch a boot-up routine and other instructions). Cloud-based storage, described in relation to FIG. 4, may be used to supplement storage 308 or instead of storage 308.

Control circuitry 304 may include video generating circuitry and tuning circuitry, such as one or more analog tuners, one or more MPEG-2 decoders or other digital decoding circuitry, high-definition tuners, or any other suitable tuning or video circuits or combinations of such circuits. Encoding circuitry (e.g., for converting over-the-air, analog, or digital signals to MPEG signals for storage) may also be provided. Control circuitry 304 may also include scaler circuitry for upconverting and downconverting content into the preferred output format of the user equipment 300. Circuitry 304 may also include digital-to-analog converter circuitry and analog-to-digital converter circuitry for converting between digital and analog signals. The tuning and encoding circuitry may be used by the user equipment device to receive and to display, to play, or to record content. The tuning and encoding circuitry may also be used to receive guidance data. The circuitry described herein, including for example, the tuning, video generating, encoding, decoding, encrypting, decrypting, scaler, and analog/digital circuitry, may be implemented using software running on one or more general purpose or specialized processors. Multiple tuners may be provided to handle simultaneous tuning functions (e.g., watch and record functions, picture-in-picture (PIP) functions, multiple-tuner recording, etc.). If storage 308 is provided as a separate device from user equipment 300, the tuning and encoding circuitry (including multiple tuners) may be associated with storage 308.

A user may send instructions to control circuitry 304 using user input interface 310. User input interface 310 may be any suitable user interface, such as a remote control, mouse, trackball, keypad, keyboard, touch screen, touchpad, stylus input, joystick, voice recognition interface, or other user input interfaces. Display 312 may be provided as a stand-alone device or integrated with other elements of user equipment device 300. For example, display 312 may be a touchscreen or touch-sensitive display. In such circumstances, user input interface 312 may be integrated with or combined with display 312. Display 312 may be one or more of a monitor, a television, a liquid crystal display (LCD) for a mobile device, amorphous silicon display, low temperature poly silicon display, electronic ink display, electrophoretic display, active matrix display, electro-wetting display, electrofluidic display, cathode ray tube display, light-emitting diode display, electroluminescent display, plasma display panel, high-performance addressing display, thin-film transistor display, organic light-emitting diode display, surface-conduction electron-emitter display (SED), laser television, carbon nanotubes, quantum dot display, interferometric modulator display, or any other suitable equipment for displaying visual images. In some embodiments, display 312 may be HDTV-capable. In some embodiments, display 312 may be a 3D display, and the interactive media guidance application and any suitable content may be displayed in 3D. A video card or graphics card may generate the output to the display 312. The video card may offer various functions such as accelerated rendering of 3D scenes and 2D graphics, MPEG-2/MPEG-4 decoding, TV output, or the ability to connect multiple monitors. The video card may be any processing circuitry described above in relation to control circuitry 304. The video card may be integrated with the control circuitry 304. Speakers 314 may be provided as integrated with other elements of user equipment device 300 or may be stand-alone units. The audio component of videos and other content displayed on display 312 may be played through speakers 314. In some embodiments, the audio may be distributed to a receiver (not shown), which processes and outputs the audio via speakers 314.

The guidance application may be implemented using any suitable architecture. For example, it may be a stand-alone application wholly-implemented on user equipment device 300. In such an approach, instructions of the application are stored locally (e.g., in storage 308), and data for use by the application is downloaded on a periodic basis (e.g., from an out-of-band feed, from an Internet resource, or using another suitable approach). Control circuitry 304 may retrieve instructions of the application from storage 308 and process the instructions to generate any of the displays discussed herein. Based on the processed instructions, control circuitry 304 may determine what action to perform when input is received from input interface 310. For example, movement of a cursor on a display up/down may be indicated by the processed instructions when input interface 310 indicates that an up/down button was selected.

In some embodiments, the media guidance application is a client-server based application. Data for use by a thick or thin client implemented on user equipment device 300 is retrieved on-demand by issuing requests to a server remote to the user equipment device 300. In one example of a client-server based guidance application, control circuitry 304 runs a web browser that interprets web pages provided by a remote server. For example, the remote server may store the instructions for the application in a storage device. The remote server may process the stored instructions using circuitry (e.g., control circuitry 304) and generate the displays discussed above and below. The client device may receive the displays generated by the remote server and may display the content of the displays locally on equipment device 300. This way, the processing of the instructions is performed remotely by the server while the resulting displays are provided locally on equipment device 300. Equipment device 300 may receive inputs from the user via input interface 310 and transmit those inputs to the remote server for processing and generating the corresponding displays. For example, equipment device 300 may transmit a communication to the remote server indicating that an up/down button was selected via input interface 310. The remote server may process instructions in accordance with that input and generate a display of the application corresponding to the input (e.g., a display that moves a cursor up/down). The generated display is then transmitted to equipment device 300 for presentation to the user.

In some embodiments, the media guidance application is downloaded and interpreted or otherwise run by an interpreter or virtual machine (run by control circuitry 304). In some embodiments, the guidance application may be encoded in the ETV Binary Interchange Format (EBIF), received by control circuitry 304 as part of a suitable feed, and interpreted by a user agent running on control circuitry 304. For example, the guidance application may be an EBIF application. In some embodiments, the guidance application may be defined by a series of JAVA-based files that are received and run by a local virtual machine or other suitable middleware executed by control circuitry 304. In some of such embodiments (e.g., those employing MPEG-2 or other digital media encoding schemes), the guidance application may be, for example, encoded and transmitted in an MPEG-2 object carousel with the MPEG audio and video packets of a program.

User equipment device 300 of FIG. 3 can be implemented in system 400 of FIG. 4 as user television equipment 402, user computer equipment 404, wireless user communications device 406, or any other type of user equipment suitable for accessing content, such as a non-portable gaming machine. For simplicity, these devices may be referred to herein collectively as user equipment or user equipment devices, and may be substantially similar to user equipment devices described above. User equipment devices, on which a media guidance application may be implemented, may function as a standalone device or may be part of a network of devices. Various network configurations of devices may be implemented and are discussed in more detail below.

A user equipment device utilizing at least some of the system features described above in connection with FIG. 3 may not be classified solely as user television equipment 402, user computer equipment 404, or a wireless user communications device 406. For example, user television equipment 402 may, like some user computer equipment 404, be Internet-enabled allowing for access to Internet content, while user computer equipment 404 may, like some television equipment 402, include a tuner allowing for access to television programming. The media guidance application may have the same layout on various different types of user equipment or may be tailored to the display capabilities of the user equipment. For example, on user computer equipment 404, the guidance application may be provided as a web site accessed by a web browser. In another example, the guidance application may be scaled down for wireless user communications devices 406.

In system 400, there is typically more than one of each type of user equipment device but only one of each is shown in FIG. 4 to avoid overcomplicating the drawing. In addition, each user may utilize more than one type of user equipment device and also more than one of each type of user equipment device.

In some embodiments, a user equipment device (e.g., user television equipment 402, user computer equipment 404, wireless user communications device 406) may be referred to as a “second screen device.” For example, a second screen device may supplement content presented on a first user equipment device. The content presented on the second screen device may be any suitable content that supplements the content presented on the first device. In some embodiments, the second screen device provides an interface for adjusting settings and display preferences of the first device. In some embodiments, the second screen device is configured for interacting with other second screen devices or for interacting with a social network. The second screen device can be located in the same room as the first device, a different room from the first device but in the same house or building, or in a different building from the first device.

The user may also set various settings to maintain consistent media guidance application settings across in-home devices and remote devices. Settings include those described herein, as well as channel and program favorites, programming preferences that the guidance application utilizes to make programming recommendations, display preferences, and other desirable guidance settings. For example, if a user sets a channel as a favorite on, for example, the web site www.allrovi.com on their personal computer at their office, the same channel would appear as a favorite on the user's in-home devices (e.g., user television equipment and user computer equipment) as well as the user's mobile devices, if desired. Therefore, changes made on one user equipment device can change the guidance experience on another user equipment device, regardless of whether they are the same or a different type of user equipment device. In addition, the changes made may be based on settings input by a user, as well as user activity monitored by the guidance application.

The user equipment devices may be coupled to communications network 414. Namely, user television equipment 402, user computer equipment 404, and wireless user communications device 406 are coupled to communications network 414 via communications paths 408, 410, and 412, respectively. Communications network 414 may be one or more networks including the Internet, a mobile phone network, mobile voice or data network (e.g., a 4G or LTE network), cable network, public switched telephone network, or other types of communications network or combinations of communications networks. Paths 408, 410, and 412 may separately or together include one or more communications paths, such as, a satellite path, a fiber-optic path, a cable path, a path that supports Internet communications (e.g., IPTV), free-space connections (e.g., for broadcast or other wireless signals), or any other suitable wired or wireless communications path or combination of such paths. Path 412 is drawn with dotted lines to indicate that in the exemplary embodiment shown in FIG. 4 it is a wireless path and paths 408 and 410 are drawn as solid lines to indicate they are wired paths (although these paths may be wireless paths, if desired). Communications with the user equipment devices may be provided by one or more of these communications paths, but are shown as a single path in FIG. 4 to avoid overcomplicating the drawing.

Although communications paths are not drawn between user equipment devices, these devices may communicate directly with each other via communication paths, such as those described above in connection with paths 408, 410, and 412, as well as other short-range point-to-point communication paths, such as USB cables, IEEE 1394 cables, wireless paths (e.g., Bluetooth, infrared, IEEE 802-11x, etc.), or other short-range communication via wired or wireless paths. BLUETOOTH is a certification mark owned by Bluetooth SIG, INC. The user equipment devices may also communicate with each other directly through an indirect path via communications network 414.

System 400 includes content source 416 and media guidance data source 418 coupled to communications network 414 via communication paths 420 and 422, respectively. Paths 420 and 422 may include any of the communication paths described above in connection with paths 408, 410, and 412. Communications with the content source 416 and media guidance data source 418 may be exchanged over one or more communications paths, but are shown as a single path in FIG. 4 to avoid overcomplicating the drawing. In addition, there may be more than one of each of content source 416 and media guidance data source 418, but only one of each is shown in FIG. 4 to avoid overcomplicating the drawing. (The different types of each of these sources are discussed below.) If desired, content source 416 and media guidance data source 418 may be integrated as one source device. Although communications between sources 416 and 418 with user equipment devices 402, 404, and 406 are shown as through communications network 414, in some embodiments, sources 416 and 418 may communicate directly with user equipment devices 402, 404, and 406 via communication paths (not shown) such as those described above in connection with paths 408, 410, and 412.

Content source 416 may include one or more types of content distribution equipment including a television distribution facility, cable system headend, satellite distribution facility, programming sources (e.g., television broadcasters, such as NBC, ABC, HBO, etc.), intermediate distribution facilities and/or servers, Internet providers, on-demand media servers, and other content providers. NBC is a trademark owned by the National Broadcasting Company, Inc., ABC is a trademark owned by the American Broadcasting Company, Inc., and HBO is a trademark owned by the Home Box Office, Inc. Content source 416 may be the originator of content (e.g., a television broadcaster, a Webcast provider, etc.) or may not be the originator of content (e.g., an on-demand content provider, an Internet provider of content of broadcast programs for downloading, etc.). Content source 416 may include cable sources, satellite providers, on-demand providers, Internet providers, over-the-top content providers, or other providers of content. Content source 416 may also include a remote media server used to store different types of content (including video content selected by a user), in a location remote from any of the user equipment devices. Systems and methods for remote storage of content, and providing remotely stored content to user equipment are discussed in greater detail in connection with Ellis et al., U.S. Pat. No. 7,761,892, issued Jul. 20, 2010, which is hereby incorporated by reference herein in its entirety.

Media guidance data source 418 may provide media guidance data, such as the media guidance data described above. Media guidance data may be provided to the user equipment devices using any suitable approach. In some embodiments, the guidance application may be a stand-alone interactive television program guide that receives program guide data via a data feed (e.g., a continuous feed or trickle feed). Program schedule data and other guidance data may be provided to the user equipment on a television channel sideband, using an in-band digital signal, using an out-of-band digital signal, or by any other suitable data transmission technique. Program schedule data and other media guidance data may be provided to user equipment on multiple analog or digital television channels.

In some embodiments, guidance data from media guidance data source 418 may be provided to users' equipment using a client-server approach. For example, a user equipment device may pull media guidance data from a server, or a server may push media guidance data to a user equipment device. In some embodiments, a guidance application client residing on the user's equipment may initiate sessions with source 418 to obtain guidance data when needed, e.g., when the guidance data is out of date or when the user equipment device receives a request from the user to receive data. Media guidance may be provided to the user equipment with any suitable frequency (e.g., continuously, daily, a user-specified period of time, a system-specified period of time, in response to a request from user equipment, etc.). Media guidance data source 418 may provide user equipment devices 402, 404, and 406 the media guidance application itself or software updates for the media guidance application.

In some embodiments, the media guidance data may include viewer data. For example, the viewer data may include current and/or historical user activity information (e.g., what content the user typically watches, what times of day the user watches content, whether the user interacts with a social network, at what times the user interacts with a social network to post information, what types of content the user typically watches (e.g., pay TV or free TV), mood, brain activity information, etc.). The media guidance data may also include subscription data. For example, the subscription data may identify to which sources or services a given user subscribes and/or to which sources or services the given user has previously subscribed but later terminated access (e.g., whether the user subscribes to premium channels, whether the user has added a premium level of services, whether the user has increased Internet speed). In some embodiments, the viewer data and/or the subscription data may identify patterns of a given user for a period of more than one year. The media guidance data may include a model (e.g., a survivor model) used for generating a score that indicates a likelihood a given user will terminate access to a service/source. For example, the media guidance application may process the viewer data with the subscription data using the model to generate a value or score that indicates a likelihood of whether the given user will terminate access to a particular service or source. In particular, a higher score may indicate a higher level of confidence that the user will terminate access to a particular service or source. Based on the score, the media guidance application may generate promotions and advertisements that entice the user to keep the particular service or source indicated by the score as one to which the user will likely terminate access.

Media guidance applications may be, for example, stand-alone applications implemented on user equipment devices. For example, the media guidance application may be implemented as software or a set of executable instructions which may be stored in storage 308, and executed by control circuitry 304 of a user equipment device 300. In some embodiments, media guidance applications may be client-server applications where only a client application resides on the user equipment device, and server application resides on a remote server. For example, media guidance applications may be implemented partially as a client application on control circuitry 304 of user equipment device 300 and partially on a remote server as a server application (e.g., media guidance data source 418) running on control circuitry of the remote server. When executed by control circuitry of the remote server (such as media guidance data source 418), the media guidance application may instruct the control circuitry to generate the guidance application displays and transmit the generated displays to the user equipment devices. The server application may instruct the control circuitry of the media guidance data source 418 to transmit data for storage on the user equipment. The client application may instruct control circuitry of the receiving user equipment to generate the guidance application displays.

Content and/or media guidance data delivered to user equipment devices 402, 404, and 406 may be over-the-top (OTT) content. OTT content delivery allows Internet-enabled user devices, including any user equipment device described above, to receive content that is transferred over the Internet, including any content described above, in addition to content received over cable or satellite connections. OTT content is delivered via an Internet connection provided by an Internet service provider (ISP), but a third party distributes the content. The ISP may not be responsible for the viewing abilities, copyrights, or redistribution of the content, and may only transfer IP packets provided by the OTT content provider. Examples of OTT content providers include YOUTUBE, NETFLIX, and HULU, which provide audio and video via IP packets. Youtube is a trademark owned by Google Inc., Netflix is a trademark owned by Netflix Inc., and Hulu is a trademark owned by Hulu, LLC. OTT content providers may additionally or alternatively provide media guidance data described above. In addition to content and/or media guidance data, providers of OTT content can distribute media guidance applications (e.g., web-based applications or cloud-based applications), or the content can be displayed by media guidance applications stored on the user equipment device.

Media guidance system 400 is intended to illustrate a number of approaches, or network configurations, by which user equipment devices and sources of content and guidance data may communicate with each other for the purpose of accessing content and providing media guidance. The embodiments described herein may be applied in any one or a subset of these approaches, or in a system employing other approaches for delivering content and providing media guidance. The following four approaches provide specific illustrations of the generalized example of FIG. 4.

In one approach, user equipment devices may communicate with each other within a home network. User equipment devices can communicate with each other directly via short-range point-to-point communication schemes described above, via indirect paths through a hub or other similar device provided on a home network, or via communications network 414. Each of the multiple individuals in a single home may operate different user equipment devices on the home network. As a result, it may be desirable for various media guidance information or settings to be communicated between the different user equipment devices. For example, it may be desirable for users to maintain consistent media guidance application settings on different user equipment devices within a home network, as described in greater detail in Ellis et al., U.S. patent application Ser. No. 11/179,410, filed Jul. 11, 2005. Different types of user equipment devices in a home network may also communicate with each other to transmit content. For example, a user may transmit content from user computer equipment to a portable video player or portable music player.

In a second approach, users may have multiple types of user equipment by which they access content and obtain media guidance. For example, some users may have home networks that are accessed by in-home and mobile devices. Users may control in-home devices via a media guidance application implemented on a remote device. For example, users may access an online media guidance application on a website via a personal computer at their office, or a mobile device such as a PDA or web-enabled mobile telephone. The user may set various settings (e.g., recordings, reminders, or other settings) on the online guidance application to control the user's in-home equipment. The online guide may control the user's equipment directly, or by communicating with a media guidance application on the user's in-home equipment. Various systems and methods for user equipment devices communicating, where the user equipment devices are in locations remote from each other, is discussed in, for example, Ellis et al., U.S. Pat. No. 8,046,801, issued Oct. 25, 2011, which is hereby incorporated by reference herein in its entirety.

In a third approach, users of user equipment devices inside and outside a home can use their media guidance application to communicate directly with content source 416 to access content. Specifically, within a home, users of user television equipment 402 and user computer equipment 404 may access the media guidance application to navigate among and locate desirable content. Users may also access the media guidance application outside of the home using wireless user communications devices 406 to navigate among and locate desirable content.

In a fourth approach, user equipment devices may operate in a cloud computing environment to access cloud services. In a cloud computing environment, various types of computing services for content sharing, storage or distribution (e.g., video sharing sites or social networking sites) are provided by a collection of network-accessible computing and storage resources, referred to as “the cloud.” For example, the cloud can include a collection of server computing devices, which may be located centrally or at distributed locations, that provide cloud-based services to various types of users and devices connected via a network such as the Internet via communications network 414. These cloud resources may include one or more content sources 416 and one or more media guidance data sources 418. In addition or in the alternative, the remote computing sites may include other user equipment devices, such as user television equipment 402, user computer equipment 404, and wireless user communications device 406. For example, the other user equipment devices may provide access to a stored copy of a video or a streamed video. In such embodiments, user equipment devices may operate in a peer-to-peer manner without communicating with a central server.

The cloud provides access to services, such as content storage, content sharing, or social networking services, among other examples, as well as access to any content described above, for user equipment devices. Services can be provided in the cloud through cloud computing service providers, or through other providers of online services. For example, the cloud-based services can include a content storage service, a content sharing site, a social networking site, or other services via which user-sourced content is distributed for viewing by others on connected devices. These cloud-based services may allow a user equipment device to store content to the cloud and to receive content from the cloud rather than storing content locally and accessing locally-stored content.

A user may use various content capture devices, such as camcorders, digital cameras with video mode, audio recorders, mobile phones, and handheld computing devices, to record content. The user can upload content to a content storage service on the cloud either directly, for example, from user computer equipment 404 or wireless user communications device 406 having content capture feature. Alternatively, the user can first transfer the content to a user equipment device, such as user computer equipment 404. The user equipment device storing the content uploads the content to the cloud using a data transmission service on communications network 414. In some embodiments, the user equipment device itself is a cloud resource, and other user equipment devices can access the content directly from the user equipment device on which the user stored the content.

Cloud resources may be accessed by a user equipment device using, for example, a web browser, a media guidance application, a desktop application, a mobile application, and/or any combination of access applications of the same. The user equipment device may be a cloud client that relies on cloud computing for application delivery, or the user equipment device may have some functionality without access to cloud resources. For example, some applications running on the user equipment device may be cloud applications, i.e., applications delivered as a service over the Internet, while other applications may be stored and run on the user equipment device. In some embodiments, a user device may receive content from multiple cloud resources simultaneously. For example, a user device can stream audio from one cloud resource while downloading content from a second cloud resource. Or a user device can download content from multiple cloud resources for more efficient downloading. In some embodiments, user equipment devices can use cloud resources for processing operations such as the processing operations performed by processing circuitry described in relation to FIG. 3.

In some embodiments, control circuitry (e.g., control circuitry 304) may identify a broadcast media asset that a user is viewing, and may aim to seamlessly transition the user to an on-demand media asset that is related to the broadcast media asset when the broadcast media asset ends. For example, control circuitry 304 may determine that the user is viewing Seinfeld on the broadcast channel ABC. Control circuitry 304 may determine that an episode of Seinfeld is available on-demand, and may seamlessly transition the user from being tuned to ABC to being tuned to an on-demand source. Upon tuning to the on-demand source, control circuitry could then generate for display the on-demand media asset.

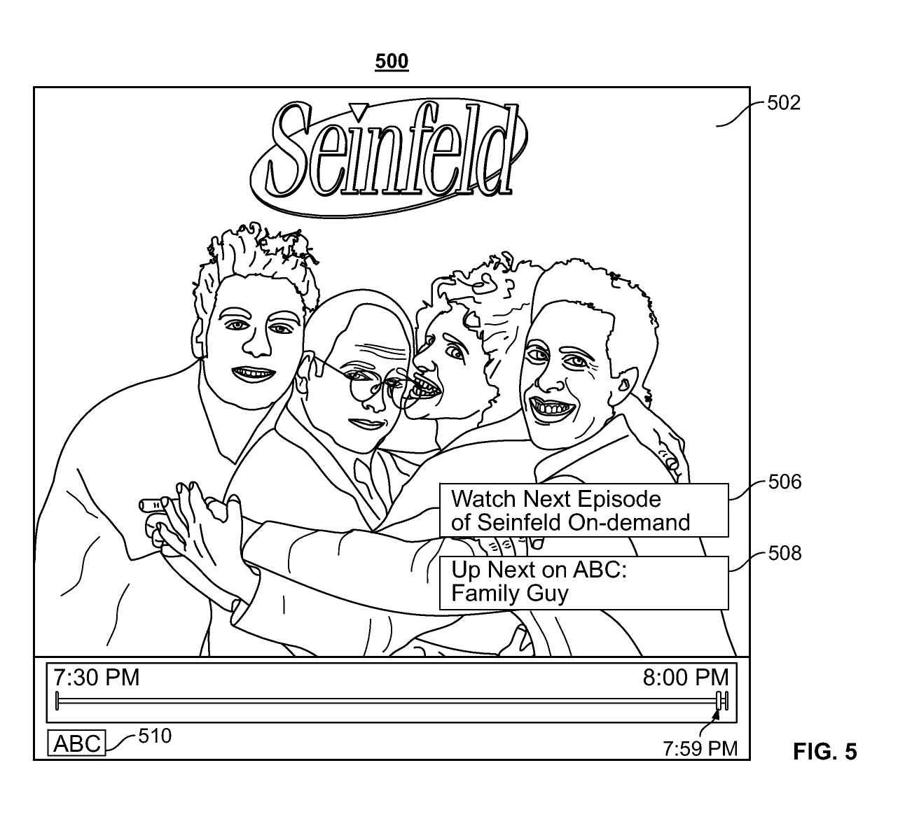

FIG. 5 shows an illustrative embodiment of a user equipment device that seamlessly transitions a user from a broadcast media asset to an on-demand media asset, in accordance with some embodiments of the disclosure. User equipment 500 is depicted as being tuned to broadcast source 510 (e.g., “ABC”), which is presently playing broadcast media asset 502 (depicted as “Seinfeld”). User equipment 500 include any functionality of any of user equipment devices 300, 402, 404, and 406. Any item depicted as displayed on user equipment 500 may be displayed via display 312.

In some embodiments, control circuitry 304 may identify a broadcast media asset that a user is viewing. For example, control circuitry 304 may identify that the user is presently viewing broadcast media asset 502 (e.g., “Seinfeld”), as provided through broadcast source 510 (e.g., “ABC”). Control circuitry 304 may identify the broadcast media asset in any known manner. As an example, control circuitry 304 may identify broadcast media asset 502 as being “Seinfeld” by analyzing VBI data transmitted along with broadcast media asset 502 to detect the identity of broadcast media asset 502 based on metadata of the VBI data. The metadata may indicate a title or other identifier of broadcast media asset 502. As another example, control circuitry 304 may consult schedule data associated with broadcast source 510. For example, control circuitry 304 may consult data of a media guidance application to learn that “Seinfeld” is scheduled to be broadcast by broadcast source 510 at a present time, and may determine, based on this learning, that broadcast media asset 502 must be “Seinfeld” based on the present time.

In some embodiments, control circuitry 304 may identify an on-demand media asset that is related to broadcast media asset 502. In order to identify an on-demand media asset that is related to broadcast media asset 502, control circuitry 304 may identify a plurality of attributes corresponding to broadcast media asset 502. For example, broadcast media asset 502 may be an episode of the sitcom television series “Seinfeld.” Control circuitry 304 may query a database (e.g., a local database at storage 306 or a remote database, such as media guidance data source 418, which is accessible by way of communications network 414) to learn what attributes correspond to broadcast media asset 502.

Control circuitry 304 may, upon learning what attributes correspond to broadcast media asset 502, query a database, such as media content source, to identify an on-demand media asset that has attributes that correspond to the attributes of broadcast media asset 502. For example, if broadcast media asset 502 is season 3, episode 2 of the television sitcom “Seinfeld,” attributes of broadcast media asset 502 may include the title of the series “Seinfeld,” the fact that it is a sitcom, actors of the media asset, and the like. Control circuitry 304 may query the database to identify on-demand media assets that share some or all of the same attributes, such as other episodes of the series “Seinfeld,” other sitcoms, and the like.

In the event that only one on-demand media asset is identified from the query, control circuitry 304 may identify that on-demand media asset as the on-demand media asset that is to be seamlessly transitioned to when broadcast media asset 502 ends. In the event that multiple on-demand media assets are identified from the query, control circuitry 304 may apply any known tie breaker in order to determine which of the multiple on-demand media assets should be seamlessly transitioned to when broadcast media asset 502 ends.

Tie breakers may include identifying an on-demand media asset of the multiple media asset that shares the most attributes with broadcast media asset 502. Another example of a tie breaker may include weighting attributes of the broadcast media asset based on a user profile, where, if a user profile indicates that certain attributes are more important to the user than other attributes, control circuitry 304 may weight those attributes more highly than other attributes. For example, if control circuitry 304 determines that a user profile reflects a strong preference for sitcoms, and reflects a weak preference for episodes of “Seinfeld,” control circuitry 304 may consider that on-demand media assets that have the attribute of being a sitcom are more likely to be of interest than a user than those that do not. Accordingly, control circuitry 304 may assign each matching attribute a numeric value, where a low value is assigned if a user does not have a preference for an attribute or has a distaste for an attribute, and a high value is assigned if control circuitry 304 determines that the user has a preference for the attribute. In one example, attributes may be assigned a value of “1,” where, if a user has a preference for an attribute, control circuitry 304 may apply a multiplier to the value where, the higher the preference of the user, the higher the multiplier that is applied. So if control circuitry 304 determines that a user enjoys “Seinfeld” episodes but really enjoys Sitcoms, on-demand media assets reflecting the attribute of “Seinfeld” may have that attribute be assigned a multiplier of two, and on-demand media assets reflecting the attribute of “sitcom” may have that attribute be assigned a multiplier of three. Control circuitry 304 may then add up the value corresponding to each attribute of each identified on-demand media asset, and select the on-demand media asset with the highest value as the on-demand media asset to be seamlessly transitioned to.

In some embodiments, control circuitry 304 may determine that broadcast media asset 502 has ended. As described above, control circuitry 304 may know the start and end time of broadcast media asset 502 by consulting a database and learning the start and end time of a media asset, and may determine that broadcast media asset 502 has ended when a present time matches the end time of the media asset. As an example, control circuitry 304 may generate for display the start and end time of broadcast media asset 502, as well as the present time, in progress bar 504. In the example depicted in FIG. 5, control circuitry 304 may indicate that “Seinfeld” begins at 7:30 pm, ends at 8:00 pm, and that the present time is 7:59.

In some embodiments, control circuitry 304 may, in response to determining that the broadcast media asset has ended, automatically generate for display the on-demand media asset. Control circuitry 304 may generate for display the on-demand media asset using any known mechanism. For example, if on-demand media asset is offered by a remote source (e.g., media content source 416) that may be tuned to, control circuitry 304 may tune user equipment 500 to the remote source. As another example, control circuitry 304 may locally store the on-demand media asset (e.g., at storage 306), and may generate for display the on-demand media asset by retrieving it from local storage and generating it for display. Similarly control circuitry 304 may retrieve the on-demand media asset from a remote data source (e.g., media content source 416) and generate for display the retrieved on-demand media asset. As another example, control circuitry 304 may automatically launch an application for streaming media assets (e.g., Netflix) and automatically direct the application to stream the identified on-demand media asset.

In some embodiments, control circuitry 304 may generate for display an interactive option for returning to a broadcast source of the broadcast media asset. For example, control circuitry 304 may generate for display an overlay on top of the on-demand media asset, prompting the user to select an option if the user wishes to tune back to broadcast source 510. Control circuitry 304 may generate for display the interactive option on a device different from user equipment 500 (e.g., a user's smartphone), such that the user's viewing of the on-demand media asset is not interrupted by the notification. Interactive options 506 and 508 may include the interactive option to return to a broadcast source of broadcast media asset 502.

In response to receiving, from the user, a selection of the interactive option, control circuitry 304 may generate for display a next broadcast media asset of the broadcast source. As an example, control circuitry 304 may, in response to receiving a selection of the interactive option, cause the on-demand media asset to no longer be displayed by tuning user equipment 500 to broadcast source 510 such that the next broadcast media asset broadcast by broadcast source 510 is accessed by control circuitry 304. Upon accessing the next broadcast media asset, control circuitry 304 may generate the next broadcast media asset for display on user equipment 500.

In some embodiments, control circuitry 304 may, in response to receiving a selection of an interactive option 506 or 508 for returning to broadcast source 510, control circuitry 304 may replace the on-demand media asset with the next broadcast media asset to be broadcast by broadcast source 510. In some embodiments, control circuitry 304 may generate for simultaneous display the on-demand media asset and the next broadcast media asset to be broadcast by broadcast source 510 (e.g., using a PIP window, or any other mechanism of simultaneous display).

In some embodiments, control circuitry 304 may determine that broadcast media asset 502 is about to end. Control circuitry 304 may, for example, determine that broadcast media asset 502 is scheduled to end at 8:00 pm, and may determine that the present time is 7:59 pm. Control circuitry 304 may determine that, because broadcast media asset 502 is within one minute of ending, broadcast media asset is about to end.

Control circuitry 304 may, in response to determining that broadcast media asset 502 is about to end, generate for display a notification that the on-demand media asset will be played when the broadcast media asset ends. As an example, notification 506 may be generated for display on user equipment 500. Notification 506 may be non-interactive, where control circuitry 304 generates for display notification 506 simply to inform the user that control circuitry 304 will, upon broadcast media asset 502 ending, cause an on-demand media asset to be generated for display. Control circuitry 304 may indicate which on-demand media asset will be generated for display. In some embodiments, notification 506 may be interactive, where a user may select a selectable option to access the on-demand media asset. In some embodiments, notification 506 may provide a menu of media assets that are related to broadcast media asset 502 (as described above and below), and may enable the user to select an on-demand media asset from the menu for retrieval and playback.

In some embodiments, control circuitry 304 may generate for display notification 508. Notification 508 may have similar functionality to notification 506. Notification 508 may indicate a next media asset to be broadcast by broadcast source 510. Notification 508 may be interactive, where, when control circuitry 304 detects a selection of notification 508, control circuitry 304 refrains from generating for display the on-demand media asset, such that the next broadcast media asset to be provided by broadcast source 510 is caused to be displayed on user equipment 500. Control circuitry 304 may, alternatively, generate for display notification 508 when the on-demand media asset is playing, such that, in response to detecting a selection of notification 508, control circuitry 304 causes user equipment 500 to tune back to broadcast source 510 in order to view the next media asset provided by broadcast source 510.

In some embodiments, control circuitry 304 may determine that playback of the on-demand media asset has ended. Control circuitry 304 may perform this determination in any manner described above or below, or may additionally learn the playback time from the source of the on-demand media asset, and rely on that playback time to determine whether or not playback has ended. In response to determining that the playback of the on-demand media asset has ended, control circuitry 304 may generate for display a second broadcast media asset, where the second broadcast media asset is received from a broadcast source that provided the initial broadcast media asset. For example, control circuitry 304 may tune back to broadcast source 510 when control circuitry 304 determines that playback of the on-demand media asset has ended. Upon tuning back, control circuitry may generate for display the content being broadcast by broadcast source 510 (i.e., the second broadcast media asset).

In some embodiments, control circuitry 304 may determine whether a second broadcast media asset that is to follow broadcast media asset 510 when broadcast media asset 510 has ended is preferred by the user. Control circuitry 304 may perform this determination by retrieving a user profile (e.g., from storage 306 or media guidance data source 418) and analyzing the user profile to learn the user's preferences. Control circuitry 304 may compare attributes of the on-demand media asset to data of the user profile. Control circuitry 304 may also or alternatively compare attributes of the second broadcast media asset to data of the user profile. Control circuitry 304 may then determine whether the user profile reflects a likely preference to view the second broadcast media asset. In response to this determination, control circuitry 304 may refrain from automatically generating for display the on-demand media asset. As such, control circuitry 304 will enable the user to view the second media asset that the user prefers, rather than the on-demand media asset.

In some embodiments, control circuitry 304 may, upon determining that the user prefers the second broadcast media asset instead of the on-demand media asset, control circuitry 304 may generate for display a selectable option such as notification 506 for refraining from automatically generating for display the on-demand media asset. If control circuitry 304 detects a selection of the selectable option, control circuitry 304 may refrain from automatically generating for display the on-demand media asset. If control circuitry 304, however, does not detect a selection of the selectable option by the time broadcast media asset 502 ends, control circuitry 304 may generate for display the on-demand media asset.

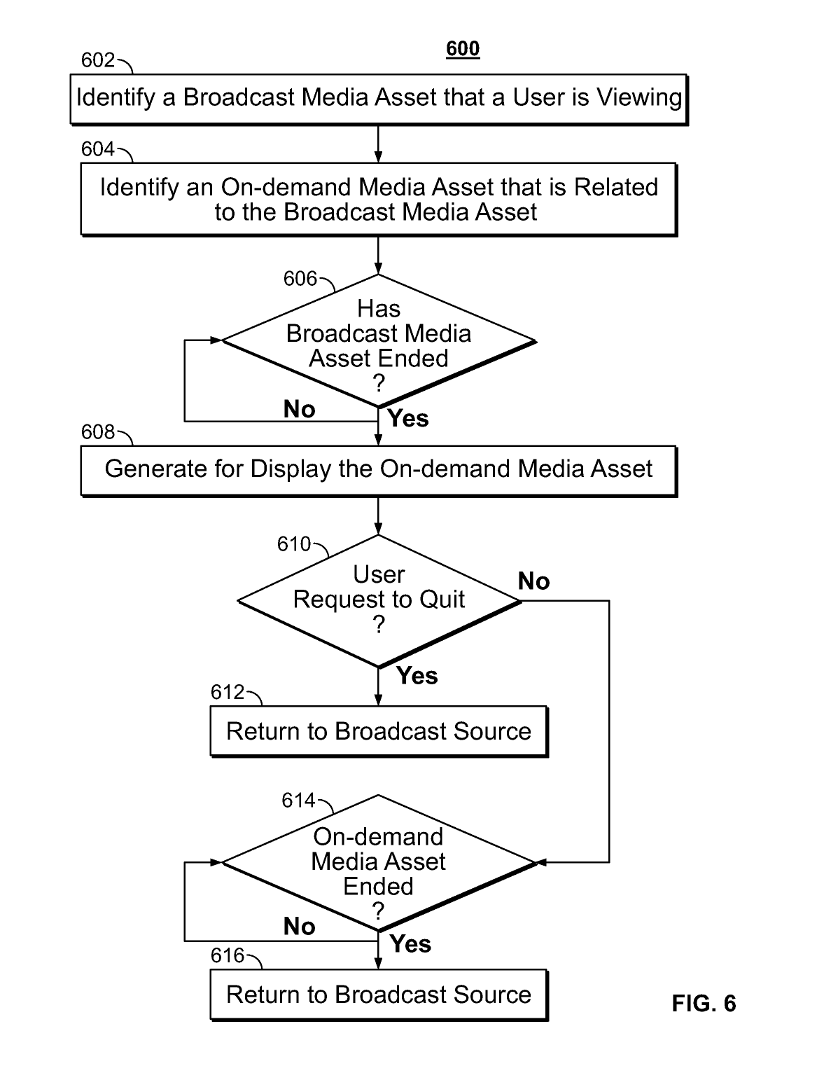

FIG. 6 is a flowchart of illustrative steps involved in seamlessly transitioning a user from a broadcast media asset to an on-demand media asset, in accordance with some embodiments of the disclosure. It should be noted that process 600 or any step thereof could be performed on, or provided by, any of the devices shown in FIGS. 3-5. For example, process 600 may be executed by control circuitry 304 (FIG. 3) as instructed by control circuitry implemented on user equipment 402, 404, and/or 406 (FIG. 4) in order to determine whether the broadcast media asset has ended. In addition, one or more steps of process 600 may be incorporated into or combined with one or more steps of any other process or embodiment.

Process 600 begins at 602, where control circuitry 304 may identify a broadcast media asset that a user is viewing. For example, control circuitry 304 may identify that the user is presently viewing broadcast media asset 502 (e.g., “Seinfeld”), as provided through broadcast source 510 (e.g., “ABC”). Control circuitry 304 may identify the broadcast media asset in any known manner. As an example, control circuitry 304 may identify broadcast media asset 502 as being “Seinfeld” by analyzing VBI data transmitted along with broadcast media asset 502 to detect the identity of broadcast media asset 502 based on metadata of the VBI data. The metadata may indicate a title or other identifier of broadcast media asset 502. As another example, control circuitry 304 may consult schedule data associated with broadcast source 510. For example, control circuitry 304 may consult data of a media guidance application to learn that “Seinfeld” is scheduled to be broadcast by broadcast source 510 at a present time, and may determine, based on this learning, that broadcast media asset 502 must be “Seinfeld” based on the present time.

Process 600 may then continue to 604, where control circuitry 304 may identify an on-demand media asset that is related to broadcast media asset 502. In order to identify an on-demand media asset that is related to broadcast media asset 502, control circuitry 304 may identify a plurality of attributes corresponding to broadcast media asset 502. For example, broadcast media asset 502 may be an episode of the sitcom television series “Seinfeld.” Control circuitry 304 may query a database (e.g., a local database at storage 306 or a remote database, such as media guidance data source 418, which is accessible by way of communications network 414) to learn what attributes correspond to broadcast media asset 502.

Control circuitry 304 may, upon learning what attributes correspond to broadcast media asset 502, query a database, such as media content source, to identify an on-demand media asset that has attributes that correspond to the attributes of broadcast media asset 502. For example, if broadcast media asset 502 is season 3, episode 2 of the television sitcom “Seinfeld,” attributes of broadcast media asset 502 may include the title of the series “Seinfeld,” the fact that it is a sitcom, actors of the media asset, and the like. Control circuitry 304 may query the database to identify on-demand media assets that share some or all of the same attributes, such as other episodes of the series “Seinfeld,” other sitcoms, and the like.

In the event that only one on-demand media asset is identified from the query, control circuitry 304 may identify that on-demand media asset as the on-demand media asset that is to be seamlessly transitioned to when broadcast media asset 502 ends. In the event that multiple on-demand media assets are identified from the query, control circuitry 304 may apply any known tie breaker in order to determine which of the multiple on-demand media assets should be seamlessly transitioned to when broadcast media asset 502 ends.

Tie breakers may include identifying an on-demand media asset of the multiple media asset that shares the most attributes with broadcast media asset 502. Another example of a tie breaker may include weighting attributes of the broadcast media asset based on a user profile, where, if a user profile indicates that certain attributes are more important to the user than other attributes, control circuitry 304 may weight those attributes more highly than other attributes. For example, if control circuitry 304 determines that a user profile reflects a strong preference for sitcoms, and reflects a weak preference for episodes of “Seinfeld,” control circuitry 304 may consider that on-demand media assets that have the attribute of being a sitcom are more likely to be of interest than a user than those that do not. Accordingly, control circuitry 304 may assign each matching attribute a numeric value, where a low value is assigned if a user does not have a preference for an attribute or has a distaste for an attribute, and a high value is assigned if control circuitry 304 determines that the user has a preference for the attribute. In one example, attributes may be assigned a value of “1,” where, if a user has a preference for an attribute, control circuitry 304 may apply a multiplier to the value where, the higher the preference of the user, the higher the multiplier that is applied. So if control circuitry 304 determines that a user enjoys “Seinfeld” episodes but really enjoys Sitcoms, on-demand media assets reflecting the attribute of “Seinfeld” may have that attribute be assigned a multiplier of two, and on-demand media assets reflecting the attribute of “sitcom” may have that attribute be assigned a multiplier of three. Control circuitry 304 may then add up the value corresponding to each attribute of each identified on-demand media asset, and select the on-demand media asset with the highest value as the on-demand media asset to be seamlessly transitioned to.

Process 600 may then continue to 606, where control circuitry 304 may determine whether broadcast media asset 502 has ended. As described above, control circuitry 304 may know the start and end time of broadcast media asset 502 by consulting a database and learning the start and end time of a media asset, and may determine that broadcast media asset 502 has ended when a present time matches the end time of the media asset. As an example, control circuitry 304 may generate for display the start and end time of broadcast media asset 502, as well as the present time, in progress bar 504. In the example depicted in FIG. 5, control circuitry 304 may indicate that “Seinfeld” begins at 7:30 pm, ends at 8:00 pm, and that the present time is 7:29 pm. If control circuitry 304 determines that the broadcast media asset 502 has not yet ended, control circuitry 304 may continue to monitor whether broadcast media asset 502 has ended. If control circuitry 304 determines that broadcast media asset 502 has ended, control circuitry 304 may continue to 608.

At 608, control circuitry 304 may, in response to determining that the broadcast media asset has ended, automatically generate for display the on-demand media asset. Control circuitry 304 may generate for display the on-demand media asset using any known mechanism. For example, if on-demand media asset is offered by a remote source (e.g., media content source 416) that may be tuned to, control circuitry 304 may tune user equipment 500 to the remote source. As another example, control circuitry 304 may locally store the on-demand media asset (e.g., at storage 306), and may generate for display the on-demand media asset by retrieving it from local storage and generating it for display. Similarly control circuitry 304 may retrieve the on-demand media asset from a remote data source (e.g., media content source 416) and generate for display the retrieved on-demand media asset. As another example, control circuitry 304 may automatically launch an application for streaming media assets (e.g., Netflix) and automatically direct the application to stream the identified on-demand media asset. Process 600 may end at 608, or may advance to 610.

If process 600 advances to 610, control circuitry 304 may determine whether a user request to quit playback of the on-demand media asset is received. If control circuitry 304 detects such a user request, process 600 may advance to 612, where control circuitry 304 may return to broadcast source 510 (e.g., by tuning to broadcast source 510) and generate for display whatever media asset is presently being broadcast by broadcast source 510. If control circuitry 304 has not detected a user request to quit playback of the on-demand media asset, process 600 may advance to 614.

At 614, control circuitry 304 may determine whether the on-demand media asset has ended. For example, control circuitry 304 may determine whether playback of the on-demand media asset is complete. If control circuitry 304 determines that the on-demand media asset has not yet ended, process 600 may remain at 614, where control circuitry 304 continues to monitor whether the on-demand media asset has ended. If control circuitry 304 determines that the on-demand media asset has ended, process 600 may advance to 616, where control circuitry 304 tunes back to broadcast source 510.

It is contemplated that the steps or descriptions of FIG. 6 may be used with any other embodiment of this disclosure. In addition, the steps and descriptions described in relation to FIG. 6 may be done in alternative orders or in parallel to further the purposes of this disclosure. For example, each of these steps may be performed in any order or in parallel or substantially simultaneously to reduce lag or increase the speed of the system or method. Furthermore, it should be noted that any of the devices or equipment discussed in relation to FIGS. 3-5 could be used to perform one or more of the steps in FIG. 6.

It will be apparent to those of ordinary skill in the art that methods involved in the present invention may be embodied in a computer program product that includes a computer-usable and/or readable medium. For example, such a computer-usable medium may consist of a read-only memory device, such as a CD-ROM disk or conventional ROM devices, or a random access memory, such as a hard drive device or a computer diskette, having a computer-readable program code stored thereon. It should also be understood that methods, techniques, and processes involved in the present invention may be executed using processing circuitry. For instance, determination of media asset ranking may be performed by processing circuitry, e.g., by processing circuitry 306 of FIG. 3. The processing circuitry, for instance, may be a general purpose processor, a customized integrated circuit (e.g., an ASIC), or a field-programmable gate array (FPGA) within user equipment 300, media content source 416, or media guidance data source 418. For example, the media asset attributes as described herein may be stored in, and retrieved from, storage 308 of FIG. 3, or media guidance data source 418 of FIG. 4. Furthermore, processing circuitry, or a computer program, may update settings associated with a user, such as user profile preferences, updating the information stored within storage 308 of FIG. 3 or media guidance data source 418 of FIG. 4.

The processes discussed above are intended to be illustrative and not limiting. One skilled in the art would appreciate that the steps of the processes discussed herein may be omitted, modified, combined, and/or rearranged, and any additional steps may be performed without departing from the scope of the invention. More generally, the above disclosure is meant to be exemplary and not limiting. Only the claims that follow are meant to set bounds as to what the present invention includes. Furthermore, it should be noted that the features and limitations described in any one embodiment may be applied to any other embodiment herein, and flowcharts or examples relating to one embodiment may be combined with any other embodiment in a suitable manner, done in different orders, or done in parallel. In addition, the systems and methods described herein may be performed in real time. It should also be noted, the systems and/or methods described above may be applied to, or used in accordance with, other systems and/or methods.

1. A method comprising:
identifying a broadcast media asset that a user is viewing;
identifying an on-demand media asset that is related to the broadcast media asset;
determining that the broadcast media asset has ended; and
in response to determining that the broadcast media asset has ended, automatically generating for display the on-demand media asset.

2. The method of claim 1, further comprising:
generating for display an interactive option for returning to a broadcast source of the broadcast media asset; and
in response to receiving, from the user, a selection of the interactive option, generating for display a next broadcast media asset of the broadcast source.

3. The method of claim 2, wherein, in response to receiving, from the user, the selection of the interactive option, causing the display of the on-demand media asset to be replaced by the display of the next broadcast media asset of the broadcast source.

4. The method of claim 1, wherein identifying an on-demand media asset that is related to the broadcast media asset comprises:
identifying a plurality of attributes corresponding to the broadcast media asset; and
identifying the on-demand media asset by querying a database to identify a media asset that shares attributes of the plurality of attributes with the broadcast media asset, and designating the identified media asset as the on-demand media asset.

5. The method of claim 4, wherein a plurality of media assets are identified as a result of the querying, and wherein identifying the on-demand media asset further comprises identifying a media asset of the plurality of media assets that, with respect to each other media asset of the plurality of media assets, has the most attributes in common with the attributes of the broadcast media asset.

6. The method of claim 1, further comprising:
determining that the broadcast media asset is about to end; and
in response to determining that the broadcast media asset is about to end, generating for display a notification that the on-demand media asset will be played back when the broadcast media asset ends.

7. The method of claim 1, wherein identifying the on-demand media asset that is related to the broadcast media asset further comprises selecting the on-demand media asset from a plurality of media assets that are related to the broadcast media asset, and wherein the selecting is based on attributes of a profile corresponding to the user.

8. The method of claim 1, further comprising:
determining that playback of the on-demand media asset has ended; and
in response to determining that the playback of the on-demand media asset has ended, generating for display a second broadcast media asset, wherein the second broadcast media asset is received from a broadcast source that provided the broadcast media asset.

9. The method of claim 1, further comprising:
determining whether a second broadcast media asset that is to follow the broadcast media asset when the broadcast media asset has ended is preferred by the user; and
in response to determining that the second broadcast media asset that is to follow the broadcast media asset when the broadcast media asset has ended is preferred by the user, refraining from automatically generating for display the on-demand media asset.

10. The method of claim 9, wherein the refraining further comprises:
generating for display a selectable option for refraining from automatically generating for display the on-demand media asset; and
in response to receiving a selection of the selectable option, refraining from automatically generating for display the on-demand media asset, such that the second broadcast media asset is caused to be generated for display.

11. A system comprising:
control circuitry configured to:
identify a broadcast media asset that a user is viewing;
identify an on-demand media asset that is related to the broadcast media asset;
determine that the broadcast media asset has ended; and
in response to determining that the broadcast media asset has ended, automatically generate for display the on-demand media asset.

12. The system of claim 11, wherein the control circuitry is further configured to:
generate for display an interactive option for returning to a broadcast source of the broadcast media asset; and
in response to receiving, from the user, a selection of the interactive option, generate for display a next broadcast media asset of the broadcast source.

13. The system of claim 12, wherein the control circuitry is further configured to, in response to receiving, from the user, the selection of the interactive option, cause the display of the on-demand media asset to be replaced by the display of the next broadcast media asset of the broadcast source.

14. The system of claim 11, wherein the control circuitry is further configured, when identifying an on-demand media asset that is related to the broadcast media asset, to:
identify a plurality of attributes corresponding to the broadcast media asset; and
identify the on-demand media asset by querying a database to identify a media asset that shares attributes of the plurality of attributes with the broadcast media asset, and designating the identified media asset as the on-demand media asset.

15. The system of claim 14, wherein a plurality of media assets are identified as a result of the querying, and wherein the control circuitry is further configured, when identifying the on-demand media asset, to identify a media asset of the plurality of media assets that, with respect to each other media asset of the plurality of media assets, has the most attributes in common with the attributes of the broadcast media asset.

16. The system of claim 11, wherein the processor is further configured to:
determine that the broadcast media asset is about to end; and
in response to determining that the broadcast media asset is about to end, generate for display a notification that the on-demand media asset will be played back when the broadcast media asset ends.

17. The system of claim 11, wherein the control circuitry is further configured, when identifying the on-demand media asset that is related to the broadcast media asset, to select the on-demand media asset from a plurality of media assets that are related to the broadcast media asset, and wherein the selecting is based on attributes of a profile corresponding to the user.

18. The system of claim 11, wherein the control circuitry is further configured to:
determine that playback of the on-demand media asset has ended; and
in response to determining that the playback of the on-demand media asset has ended, generate for display a second broadcast media asset, wherein the second broadcast media asset is received from a broadcast source that provided the broadcast media asset.

19. The system of claim 1, wherein the control circuitry is further configured to:
determine whether a second broadcast media asset that is to follow the broadcast media asset when the broadcast media asset has ended is preferred by the user; and
in response to determining that the second broadcast media asset that is to follow the broadcast media asset when the broadcast media asset has ended is preferred by the user, refrain from automatically generating for display the on-demand media asset.

20. The system of claim 19, wherein the control circuitry is further configured, when performing the refraining, to:
generate for display a selectable option for refraining from automatically generating for display the on-demand media asset; and
in response to receiving a selection of the selectable option, refrain from automatically generating for display the on-demand media asset, such that the second broadcast media asset is caused to be generated for display.

21-50. (canceled)
